(19) United States
(12) Patent Application Publication
(10) Pub. No.: US 2017/0255754 A1
(43) Pub. Date: Sep. 7, 2017

(54) Data Storage and Communications Method and System for Worker Injury Tracking and Claim Handling

(71) Applicant: Consumer Health Connections, LLC, Milwaukee, WI (US)

(72) Inventor: Jill A. Allen, Waukesha, WI (US)

(21) Appl. No.: 15/447,911

(22) Filed: Mar. 2, 2017

Related U.S. Application Data
(60) Provisional application No. 62/382,009, filed on Aug. 31, 2016.
(60) Provisional application No. 62/303,807, filed on Mar. 4, 2016.

(51) Int. Cl. G06F 19/00; H04L 29/06

(52) U.S. Cl. CPC G06F 19/328; G06F 19/3418; H04L 65/403; G06F 21/6245

(57) ABSTRACT

A method and system for tracking a worker's injury and managing the claim process relating to the injury are provided. The method including connecting parties to a video conference session, exchanging information relating to the workers injury between the parties connected to the video conference session, electronically recording at least a portion of the video conference session, storing the recorded portion of the video conference session, and linking the stored video conference session to an electronic case file containing additional information about the claim process for the worker's injury. The system including a user interface, computer networking, and a storage device all configured to carry out the method.

### CROSS-REFERENCE TO RELATED PATENT APPLICATIONS

This patent application claims the benefit of U.S. Provisional Patent Application No. 62/382,009, filed Aug. 31, 2016, and U.S. Provisional Patent Application No. 62/303,807 filed, Mar. 4, 2016, the entire teachings and disclosure of which are incorporated herein by reference thereto.

### BACKGROUND OF THE INVENTION

The present invention relates generally to the field of insurance claim management. The present invention relates specifically to a data storage and communications system and method for worker injury tracking and claim handling.

### SUMMARY OF THE INVENTION

One embodiment of the invention relates to a method for tracking a worker's injury and managing the claim process relating to the injury. The method includes connecting an injured worker to a video conference session with an insurance adjuster. The method also includes exchanging information relating to an injury suffered by the worker. The information is exchanged between the injured worker and the insurance adjuster over the video conference session. The method also includes electronically recording at least a portion of the video conference session to document the exchange of information. The method also includes storing the electronically recorded video conference session in an electronic database. The method also includes linking the stored video conference session to an electronic case file. The electronic case file containing additional information relating to the claim process for the worker's injury.

Another embodiment of the invention relates to a method for tracking a worker's injury and managing the claim process relating to the injury. The method includes connecting an injured worker to a HIPAA compliant video conference session with a healthcare provider. The method also includes exchanging information relating to an injury suffered by the worker. The information is exchanged between the injured worker and the healthcare provider over the video conference session.

Another embodiment of the invention relates to a method for tracking a worker's injury and managing the claim process relating to the injury. The method includes connecting an injured worker to a multi-party HIPAA compliant video conference session with an insurance adjuster and a healthcare provider. The method also includes exchanging information relating to an injury suffered by the worker. The information is exchanged between the injured worker, the healthcare provider, and the insurance adjuster over the video conference session.

Another embodiment of the invention relates to a system for managing workers' compensation claims. The system includes a plurality of user accounts. Each user account has credentials indicating at least a user type and level of access. The system also includes a centralized electronic portal. The centralized electronic portal includes a plurality of user interfaces, each corresponding to one of the user types. The centralized electronic portal also includes a file management module comprising a database and a plurality of actions. The plurality of action are configured to create a new workers' compensation claim file, associate at least one of the user accounts with the workers' compensation claim file, create new documents for the workers' compensation claim file and store them in the database, retrieve and display documents for the workers' compensation claim file previously stored in the database, and edit documents for the workers' compensation claim file previously stored in the database. The plurality of actions are accessible by each of the plurality of user accounts based on the user type and level of access of its corresponding credentials. The centralized electronic portal also includes a telepresence module. The telepresence module is configured to establish a video connection between at least 2 of the user accounts and record at least a portion of the video connection as a document in the database. The centralized electronic portal also includes a notification module. The notification module is configured to send an alert to at least one of the plurality of user accounts associated with the workers' compensation claim file.

Another embodiment of the invention relates to a network system including a user interface, a computer network, and a storage device configured to perform any of the methods described herein.

Alternative exemplary embodiments relate to other features and combinations of features as may be generally recited in the claims. In another aspect, the invention provides

### BRIEF DESCRIPTION OF THE DRAWINGS

This application will become more fully understood from the following detailed description, taken in conjunction with the accompanying figures, wherein like reference numerals refer to like elements in which:

FIG. 1 is a diagram of a method for worker injury tracking and claim handling according to an example embodiment.

FIG. 2 is a detailed in view of the top half of the diagram of FIG. 1.

FIG. 3 is a detailed in view of the bottom half of the diagram of FIG. 1.

FIG. 4 is a diagram of a system for managing a workers' compensation claim files according to an example embodiment.

FIG. 5 is a screenshot of graphical user interface including a data input prompt within the system of FIG. 4 according to an example embodiment.

FIG. 6 is a screenshot of a graphical user interface within the system of FIG. 4 according to an example embodiment.

FIG. 7 is a screenshot of the graphical user interface including an additional data input prompt in conjunction with a telepresence session within the system of FIG. 4.

FIG. 8 is a screenshot of the graphical user interface including the bottom portion of the data input prompt of FIG. 7.

FIG. 9 is a screenshot of the graphical user interface including a converted document produced by the system of FI. 4 according to an example embodiment.

FIG. 10 is a screenshot of a different page of the graphical user interface of FIG. 6.

FIG. 11 is a screenshot of the graphical user interface including a consent verification pop-up window within the system of FIG. 4 according to an example embodiment.

FIG. 12 is a screenshot of the graphical user interface including an add providers pop-up window within the system of FIG. 4 according to an example embodiment.

FIG. 13 is a screenshot of the graphical user interface page of FIG. 10 after an additional party has been associated with a specific workers' compensation case file.

FIG. 14 is a screenshot of the graphical user interface page of FIG. 13 in conjunction with a telepresence session within the system of FIG. 4.

FIG. 15 is a screenshot of a different page of the graphical user interface of FIG. 6.

FIG. 16 is a screenshot of a different page of the graphical user interface of FIG. 6.

FIG. 17 is a screenshot of a different page of the graphical user interface of FIG. 6.

FIG. 18 is a screenshot of the graphical user interface in conjunction with a telepresence session within the system of FIG. 4 showing a telepresence interpreter added via an add interpreter operation.

FIG. 19 is a screenshot of a graphical user interface within the system of FIG. 4 according to an example embodiment.

FIG. 20 is a screenshot of a different page of the graphical user interface of FIG. 19.

FIG. 21 is a screenshot of a window showing an embodiment of a companies claim data sorted into a company hierarchy.

### DETAILED DESCRIPTION OF THE INVENTION

Referring generally to the figures, various embodiments of a method and system for worker injury tracking and claim handling are shown. Specifically, various embodiments relating to a computer system for electronically and securely storing and communicating data associated with injury tracking and claim handling are shown. Compensation for both temporary and permanent disabilities or injuries to a worker relating to on the job activities are governed by state and federal workers' compensation laws. The workers' compensation process while slightly different among the states has several common aspects. First, most states require employers who meet a certain threshold of employees to maintain insurance for workers' compensation claims. Second, the states require the employee to notify the employer and/or the employer's insurance carrier about the injury within a specific time frame. The time frame for notification is usually around 30-45 days from the time the injury becomes known. However, the exact time requirements are set by the specific laws in each state and/or federal law.

Notification usually takes place in one of two ways. First, a worker suffers an on the job injury and notifies the employer directly. The employer then has the injured worker fill out a form documenting the injury and initiating a workers' compensation claim. Once the employer is notified, the employer will notify its insurance carrier of the claim, and the insurance carrier will take over management of the claim process. Otherwise, prior to notifying the employer, a worker who suffers an injury goes to see a healthcare provider (e.g. doctor, nurse, etc.) about the injury, and the healthcare provider determines whether the injury is a work related injury. The healthcare provider will then have the worker fill out the healthcare provider's own workers' compensation claim form that will advise the employer and the insurance carrier about the injury. The employer may find out about an employee's work injury through a Return to Work form or once a medical bill is received.

Following the notification, the claim process will proceed between the worker and the insurance carrier. The process involves multiple examinations of the worker from the worker's personal healthcare provider and/or an additional healthcare provider provided by the insurance carrier. Additionally, the worker will be interviewed by an adjuster employed by the insurance carriers. Each of these examinations and interviews will produce various reports that the insurance carrier will use to decide whether to accept or reject the worker's claim. In the conventional process, the reports are often not compiled together. This is especially true for reports from a worker's personal healthcare provider, which have to be specially requested and are not generated specifically in relation to the workers' compensation claim process. The dispersed nature of the information increases the cost and decreases the effectiveness of the insurance carrier's review. Further, both the nature of the information as well as the typical time delay between the initial injury and the initial report of the injury increase the risk of various issues, including delayed claim handling, inaccurate records, and/or fraud. The risk of these issues can be further increased because the initial injury report is normally only documented in a paper record and often the record is filled out by the injured worker themselves. The delayed reporting process also delays timely and appropriate treatment. Accordingly, Applicant has identified the need for a centralized system to manage, store, and communicate all of the data relating to a workers' compensation claim, facilitate quick reporting of the injury, and document the initial injury as a recorded and stored visual report rather than a paper description.

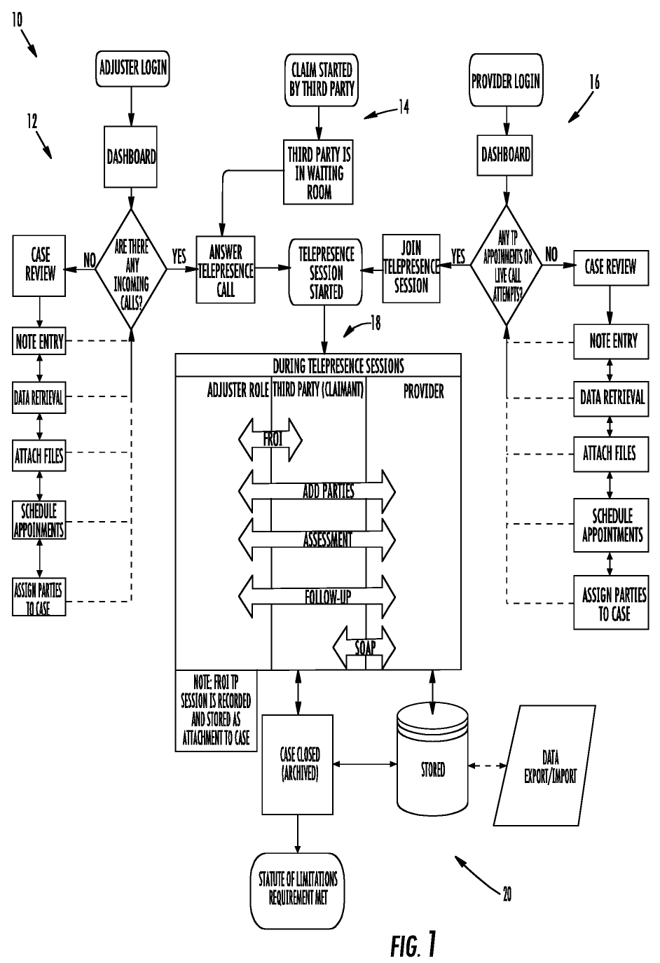

Referring to FIG. 1, a flow diagram of an example embodiment of a method 10 for tracking a worker's injury and managing the claim process relating to the injury is shown. In one embodiment, method 10 is implemented with a computer system having a user interface, a computer network, and a storage device. The system is also configured with suitable software and hardware for performing method 10. Method 10 has an insurance adjuster stage 12, an injured worker or third party stage 14, a healthcare provider stage 16, a telepresence or video conference stage 18, and a backend electronic data management or database stage 20.

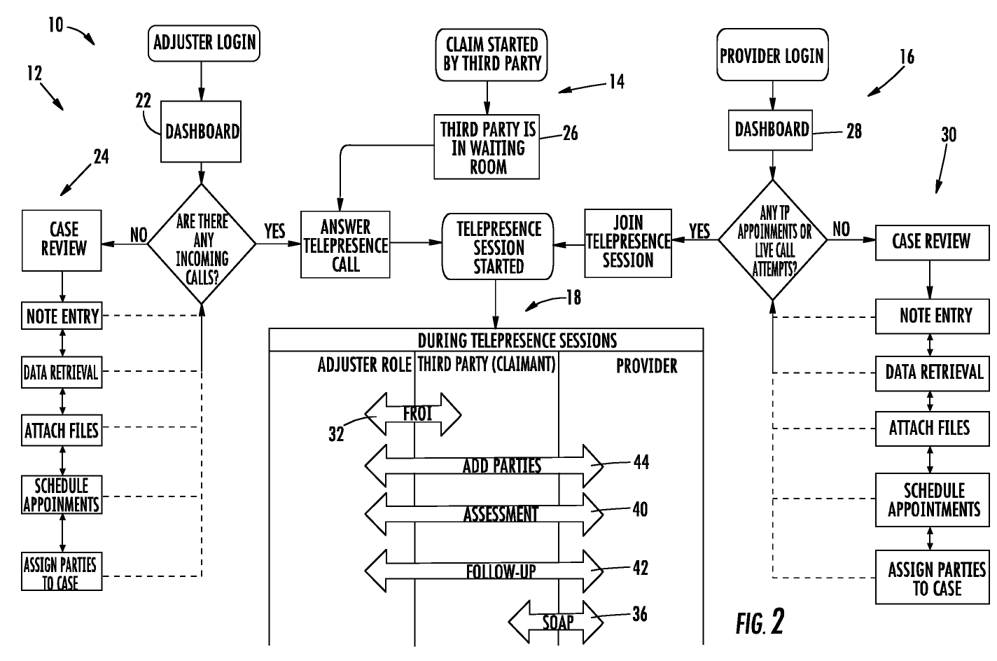

Referring to FIG. 2, a detailed diagram showing the top portion of the example embodiment of method 10 depicted in FIG. 1 is shown. As shown, insurance adjuster stage 12 provides steps for an authorized insurance adjuster to access a workers' compensation case file. The system receives a login from an insurance adjuster (e.g. claim handler, insurance company employee, employer human resources representative, etc.) and grants accesses to a dedicated adjuster dashboard 22. From adjuster dashboard 22, the system grants the insurance adjuster access to a case file, multiple case files or connects them to an incoming video conference or telepresence request. Accessing the case files gives the adjuster access to claim processing tasks 24. Claim processing tasks 24 include reviewing an existing case file or files that are stored in an electronic database. Additional tasks include, noting entries in a case file, retrieving data stored in a case file, attaching new files to a case file, scheduling appointments, and assigning parties to a case. In one embodiment, the access rights to specific case files or parts of specific case files are dependent on credentials of the adjuster provided at the login step. For example, the adjuster would only be able to access cases files that they are assigned to by the insurance carrier.

Still referring to FIG. 2, in injured worker stage 14, the system receives an initiated claim from an injured worker. The initiated claim is generated at a workstation or computer by the worker. In one embodiment, the claim initiating workstation is remote from the adjuster and the healthcare provider. Following the initiated claim, the system transfers the injured worker to a third party waiting room 26. The system then connects the injured worker with one or more parties and starts a video conference session between those parties and initiates video conference stage 18. In one embodiment, the system connects the insurance adjuster from adjuster stage 12 with the injured worker. In another embodiment, system connects the injured worker with a healthcare provider from healthcare provider stage 16. In another embodiment, the system connects the injured worker with both the adjuster and the healthcare provider. Where the system connects the healthcare provider to the video conference session, the connection is such that it complies with the requirements of the Health Insurance Portability and Accountability Act (“HIPAA”) relating to the protection of patient records and information. Such HIPPA compliant connections include secure communication links and/or data encryption. It should be understood that various embodiments of the system and method involve a wide variety of different parties and/or entities (e.g. patients, hospital staff, hospital administrators, etc.). In such systems and methods the data communicated and stored relate to those parties. For example, data stored or communicated may relate to a case file in a health care setting.

Healthcare provider stage 16 mirrors adjuster stage 12. The system receives a login from a healthcare provider (e.g. doctor, nurse, etc.). The system transfers the provider to a dedicated provider dashboard. From there, the system grants the provider access to claim processing tasks 30. Claim processing tasks 30 include reviewing an existing case file or files that are stored in an electronic database. Additional tasks include noting entries in a case file, retrieving data stored in a case file, attaching new files to a case file, scheduling appointments, and assigning parties to a case. Claim processing tasks 30 may be the same or different from claim processing tasks 24. In one embodiment, the access rights to specific case files or parts of specific case files are dependent on credentials of the healthcare provider provided at the login step. For example, a specific healthcare provider would only be granted access to cases pertaining to their patient. Further, the healthcare provider would only be allowed to view or modify case records relating to the medical portion of the injury claim.

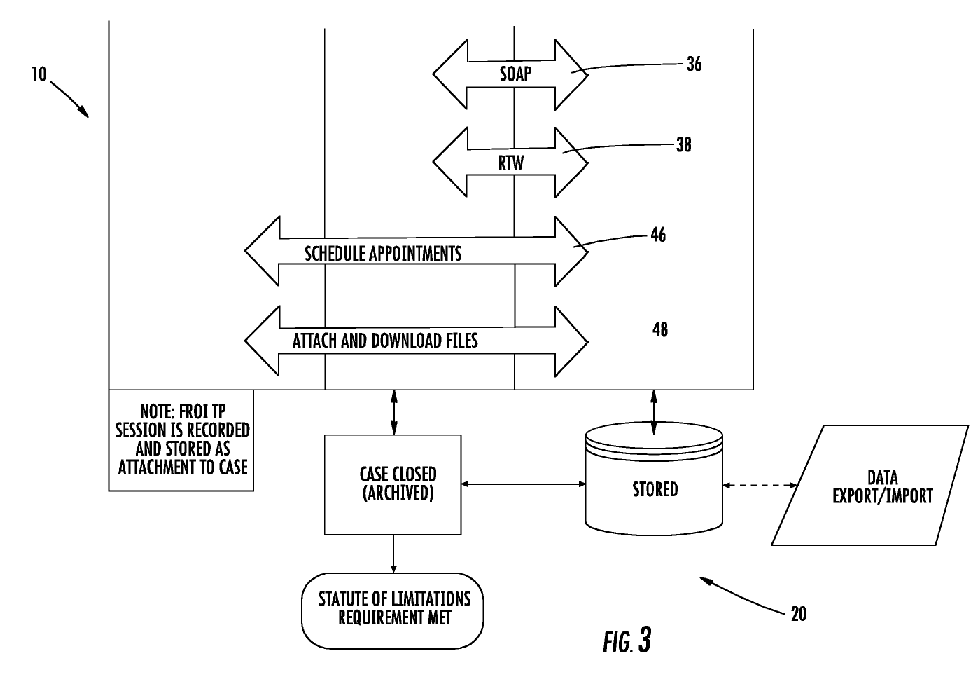

During video conference stage 18, the system facilitates the exchange of information relating to the injury suffered by the worker. The information is exchanged between the parties that are connected to the session in injured worker stage 14. As shown in FIG. 2 and FIG. 3, the specific information exchanged is dependent on which parties are connected to the video conference session. In one embodiment, where the parties are the adjuster and the injured worker, the exchanged information is a first report of the injury or incident (“FROI”) 32. In one embodiment, where the parties are the healthcare provider and the injured worker the exchanged information is a subjective, objective, assessment, and plan (“S.O.A.P.”) note 36 and/or a return to work form or order 38. In another embodiment, where the parties are the healthcare provider the injured worker and the insurance adjuster, the exchanged information is first assessment 40 or follow up assessment 42 of the injury.

During video conference stage 18, the system electronically records at least a portion of the video conference session. This recording includes video data and/or data. The recording may also include time/date data, and/or geotag location data. Recording the video conference session creates video evidence documenting the extent of the worker's injury as an objective record as opposed to a personal written account as with the forms currently used in workers' compensation claims. Creating a video record preserves additional information including body language and visuals of the claimed injury itself. Documenting this evidence makes identifying fraud easier because it provides a contemporaneous and objective record of the injury and context to the worker's statements. Further, a genuine claim will receive faster disposition because the adjuster and the insurance carrier can rely on this objective record to more easily determine that a claim is a legitimate injury.

As shown in FIG. 2 and FIG. 3, the system facilitates additional actions during video conference stage 18. The additional actions include adding parties 44, scheduling additional appointments 46, and/or attaching and downloading files 48. The additional actions generate data which is passed to database stage 20. In one embodiment, the system facilitates the additional actions regardless of which parties are connected to the video conference. In another embodiment, the additional actions are limited to the case where the video conference session includes the injured worker, the adjuster and the healthcare provider.

Once the video conference session is ended, the system passes the recorded session to database stage 20 as shown in FIG. 3. In database stage 20, the system stores the recorded portion of the video conference session and any data associated with the additional actions in an electronic database or similar electronic data storage medium (e.g. memory, mainframe, web server, etc.). The system then links the recorded video conference and any data associated with the additional actions to an electronic case file containing additional information relating to the claim. The additional information can include previously stored video conference sessions, S.O.A.P. notes, return to work orders, medical reports documenting the injury, notes from one or more healthcare providers, notes from one or more insurance adjusters, lists of additional parties connected to the case, and/or lists of scheduled appointments. In one embodiment, the additional information is stored in compliance with HIPPA patient data security requirements.

In one embodiment, the case file is created by the system in database stage 20. Additional information is added to the case file in subsequent video conference sessions and/or through claim processing tasks 24 and 30 by the adjuster and healthcare provider respectively. In another embodiment, the system links the recorded video conference and any data associated with the additional actions to an existing case file and then stores the recording and data in an electronic storage location dedicated for the existing case file. In another embodiment, the video conference and data are stored in compliance with HIPPA patient data security requirements.

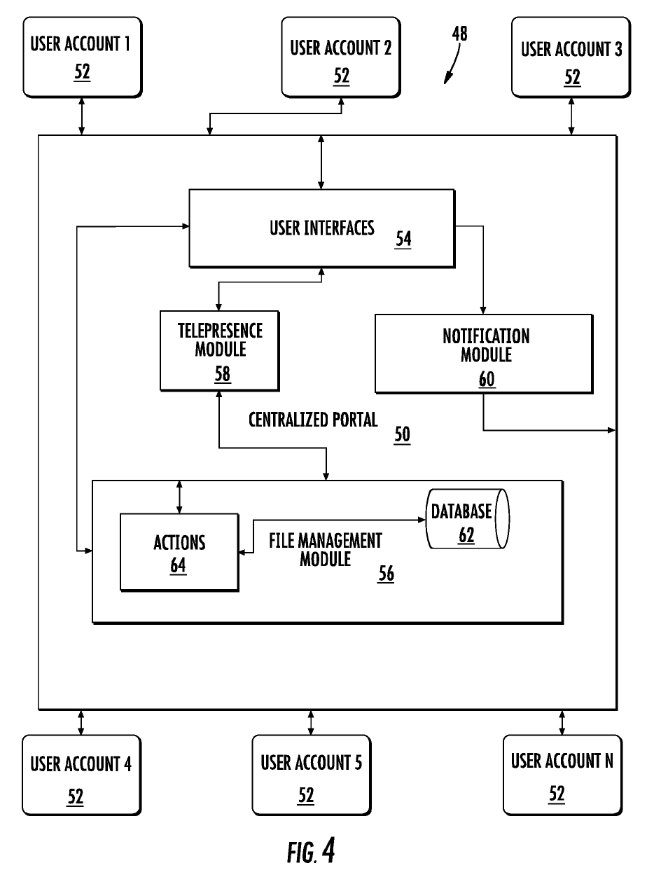

Referring now to FIG. 4, a diagram of an example embodiment of a system for managing workers' compensation claims is shown. Claim management system 48 includes a centralized portal 50 and a plurality of user accounts 52. Centralized portal 50 includes a plurality of interconnected interfaces and modules for managing every aspect of a workers' compensation claim file. In one embodiment, centralized portal 50 includes a plurality of user interfaces or dashboards 54, a file management module 56, a telepresence module 58, and a notification module 60.

System 48 is configured to have a virtually limitless number of user accounts. Each individual user account of the plurality of user accounts 52 has credentials that identify at least a user type and a level of access. In one embodiment, the user types include adjuster, healthcare provider, worker/employee, employer, and nurse. Various embodiments having different amounts and types of user account are contemplated. The level of access portion of the credentials indicates the specific workers' compensation claim files that the user account can access. The user type portion of the credentials indicates the types of actions the system allows that user account to perform. Employing at least two separate credential data points allows the system to limit the access for users of the same type to only specific claim files. For example, a claim adjuster may only be assigned a small fraction of cases to manage and the system would limit that adjuster's user account such that they would only have access to the assigned cases.

Plurality of user accounts 52 are connected to centralized portal 50 and are configured to login to centralized portal 50 using multiple access points. Those access points include at least a full web interface, a mobile web interface, and a dedicated mobile application interface. Once a user account logs in, it is presented with a user interface from the plurality of user interfaces 54. The user interface displayed to the user account is based on the user type associated with the specific user account's credentials. In another embodiment, the specific user interface displayed is also dependent on the specific access point used to log-in to centralized portal 50. For example, the user interface for adjusters logging on using the full web interfaces would be different from the user interface for adjusters logging on using the mobile web or application interfaces. Additionally, the user interface for the other user types will be different from that of the adjuster type. In one embodiment, the worker/employee user type has limited access to the interfaces and modules of centralized portal 50 and is simply presented with various data prompts and/or telepresence requests at the discretion of one of the other user types such as the Adjuster type. User interfaces 54 are connected to file management module 56, telepresence module 58, and notification module 60. User interfaces 54 manage the interaction between the various modules and provide each user account access to each of the modules based on its respective credentials.

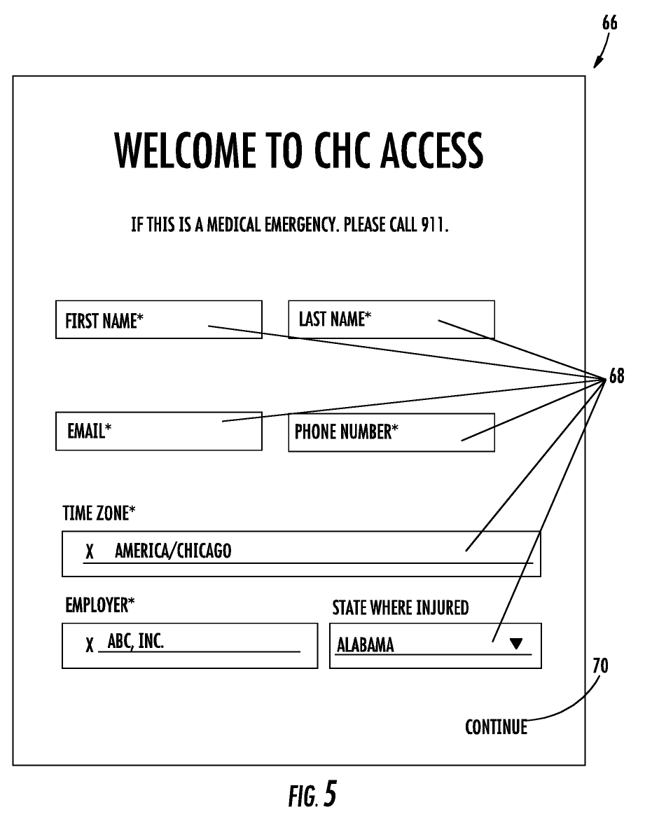

File management module 56 includes a database 62 and a plurality of actions 64. Actions 64 are configured to be called by user interfaces 54 and manipulate and/or create data within database 62. In one embodiment, plurality of actions 64 are configured to create a new workers' compensation claim file and associate at least one of the user accounts with the workers' compensation claim file. Plurality of actions 64 are also configured to create new documents for the workers' compensation claim file and store the documents in the database, retrieve and display within the user interface documents for the workers' compensation claim file previously stored in the database, and edit documents for the workers' compensation claim file previously stored in the database. In one embodiment, the plurality of actions 64 are accessible by each of the plurality of user accounts 54 based on the user type and level of access of its corresponding credentials. In one embodiment, the actions include creating documents such as a first report of an incident (“FROI”), a healthcare provider's subjective, objective, assessment, and plan (“S.O.A.P.”) note, miscellaneous notes about the case file, and/or a return to work order. The actions also include converting a data to a standard form such as converting FROI data into a standard state form (see description accompanying FIG. 5-FIG. 9 below for more details). The actions also include associating a different user account with a specific case file. The actions also include uploading and storing external documents relevant to a specific workers' compensation claim file. These documents can include additional medical files such as test results or medical images. In one embodiment, the system is configured to upload and stores document of any file type.

Telepresence module 58 operates on top of user interfaces 54 and is configured to establish a video connection between at least two of the user accounts. Telepresence module 58 is further configured to record at least a portion of the video connection and store that recording as a document in database 62. In one embodiment, telepresence module 58 verifies consent to be recorded prior to initiating the video connection and stores the verification in database 62.

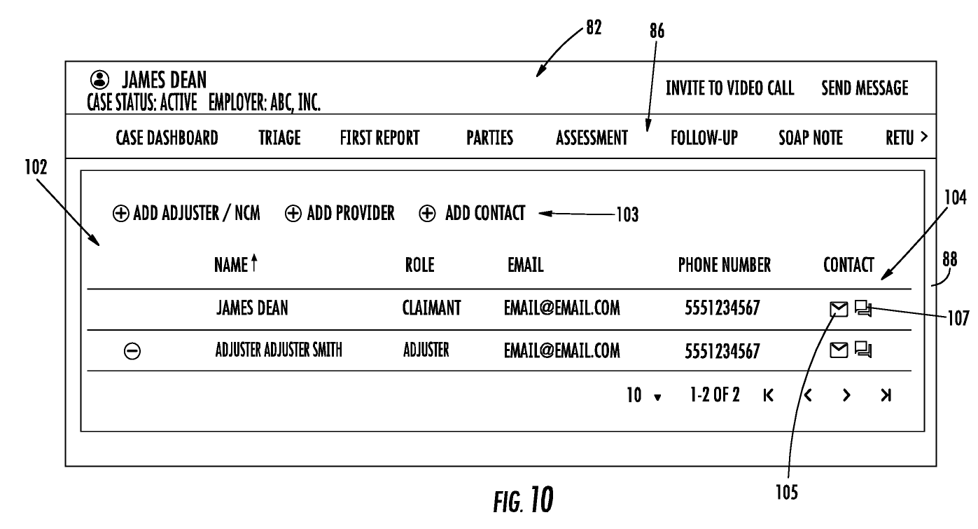

Notification module 60 is configured to send an alert out to at least one of the plurality of user accounts 52 associated with a specific claim file. In one embodiment, the alert notifies associated user accounts that a new document has been created and/or uploaded to the account. Notification module 60 is configured such that a user account of a specific type can select which associated user accounts receive a specific alert. In another embodiment, the alert is a request to join a case and/or a telepresence session (see description accompanying FIG. 10-FIG. 14 below for more details). In another embodiment, notification module 60 generates a link into centralized portal 50 that is sent along with the alert. It should be understood that various methods for sending alerts to the respective user accounts are contemplated, including at least sms text messaging and/or email.

Referring now to FIG. 5 through FIG. 9, example screenshots detailing one embodiment for the creation of an FROI form and initiation of a new workers' compensation case file within system 48 are shown. A new workers' compensation case begins when a new worker/employee type user account logs in to central portal 50 for the first time. The new user account is presented with data input prompt 66. Data input prompt 66 includes a plurality of demographic fields 68. Demographic fields 68 are configured to receive demographic data (e.g. name, email, time zone, location, etc.) from the new user account. In one embodiment, the specific information within fields 68 is used to select the specific state forms (e.g. state specific FROI form) that will be generated as a part of the workers' compensation case file. Data input prompt 66 also includes an end state operator 70 configured to close the prompt, save the entered data, and transfer the user profile to a virtual waiting room when end state operator 70 is activated.

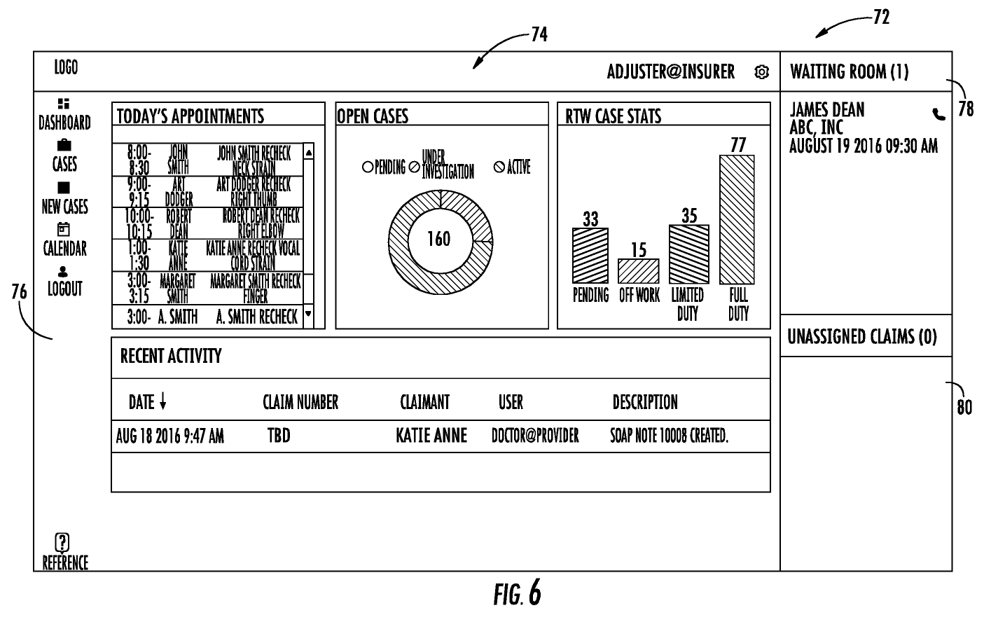

FIG. 6 shows a partial screenshot of an adjuster user interface page or dashboard 72 for an adjuster or claim manager type user account. Adjuster user interface 72 includes a main window 74 configured to show an overview of the cases assigned to the specific adjuster user account and data associated with those cases. In one embodiment, the data displayed includes upcoming appointments, status of open cases, and recent activity on the cases assigned to the specific adjuster user account. Adjuster user interface 72 also includes a selection window 76, a waiting room window 78, and an unassigned claims window 80. Selection window 76 allows the specific adjuster user account to change the current view of adjuster user interface 72 to different views such as a full calendar view and a view listing the assigned cases. Selection window 76 also allows the specific adjuster user account to log off of centralized portal 50 or create a new workers' compensation case file. Waiting room window 78 displays a clickable link to any user accounts currently in the virtual waiting room. Clicking on the clickable link transfers the corresponding user account out of the virtual waiting room and engages telepresence module 58 to initiate a telepresence session by opening a video connection between the user account associated with the link and the specific adjuster account that clicks on the link. This process in effect answers the call initiated by the new worker/employee type user account and in one embodiment automatically generates an associated workers' compensation claim file. Unassigned claims window 80 displays a list of clickable links to any claims that do not have an assigned adjuster. In one embodiment, clicking on and unassigned claim assigns the specific adjuster account to the claim associated with the link in unassigned claims window 80.

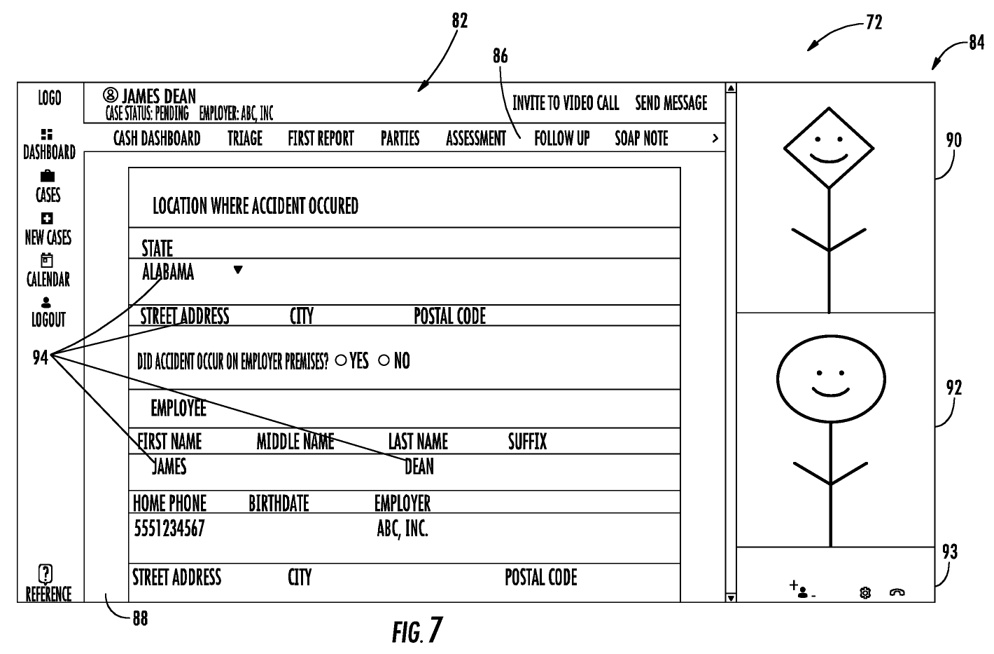

Referring now to FIG. 7 a screenshot of adjuster user interface 72 after initiating a video connection with a worker/employee user account from waiting room window 78 is shown. In one embodiment, main window 74 is replaced with case specific window 82 and waiting room window 78 and unassigned claims window 80 are replaced with telepresence window 84. Case specific window 82 includes an action selection header bar 86 and an action specific content window 88. Action selection header bar 86 includes a list of actions performable by the specific adjuster account in relation to the initiated workers' compensation claim file. The list of actions include but is not limited to: “TRIAGE” for triaging an injury to assess immediate need for medical care; “FIRST REPORT” for compiling data for an FROI report; “PARTIES” for adding or removing parties/user accounts that have access to the claim file; “ASSESSMENT” for reviewing any assessments; “FOLLOW-UP” to initiate a follow up with the worker/employee; and “SOAP NOTE” to review an S.O.A.P. note. Each of the actions can be accessed independently of a telepresence session by accessing a specific case file the adjuster is already assigned to. The action specific content window 88 displays data and/or data entry fields associated with the specific action selected from action selection header bar 86.

Telepresence window 84 includes a remote view window 90 displaying the video connection to the worker/employee user account, a local view window 92 displaying the video connection to the adjuster user account, and a telepresence settings bar 93 for controlling the operations of telepresence module 58 such as recording at least a portion of the video connection. Local view window 92 displays the video image that is transferred from the specific adjuster account to the worker/employee user account. In one embodiment, local view window 92 is omitted and only remote view window 90 is displayed. In another embodiment, local view window 92 is a thumbnail window superimposed over a portion of remote view window 92.

In one embodiment, when a new claim file is initiated along with a telepresence session the first report action is selected by default from action selection header bar 86. Action specific window 88 associated with the first report action includes a plurality of FROI report fields 94 that correspond to required information fields on the state FROI form for the jurisdiction selected by the employee/worker user account. Each FROI report field 94 is specifically associated with fields on the state FROI form such that data within FROI report field 94 can be electronically written to a state FROI form to produce a complete and compliant form that can be submitted to the appropriate state agency. A subset of FROI report fields 94 correspond to the demographic data received in fields 68 of data input prompt 66. In one embodiment, the demographic data is automatically populated into FROI report fields 94. FROI report fields 94 that are not automatically populated receive additional data from the specific adjuster user account that correspond to information being conveyed over the video connection with the employee/worker user account.

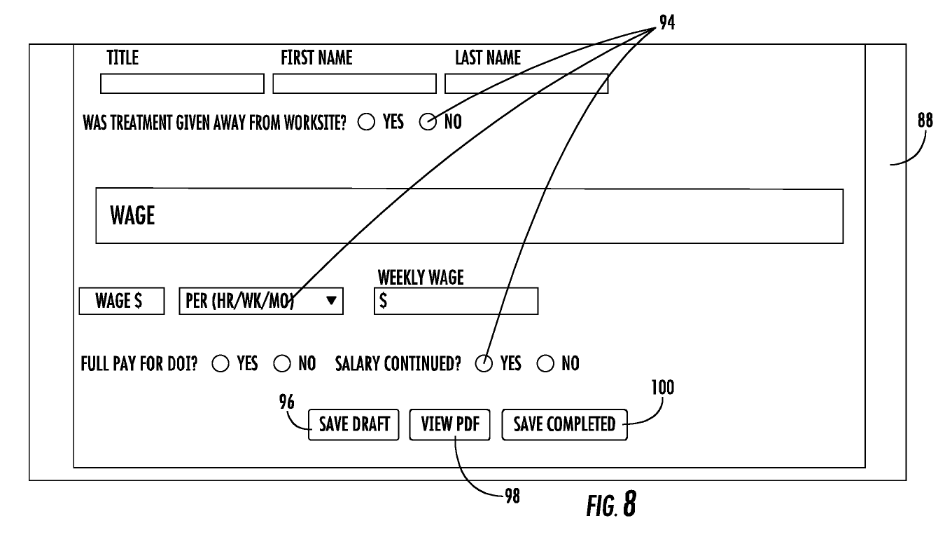

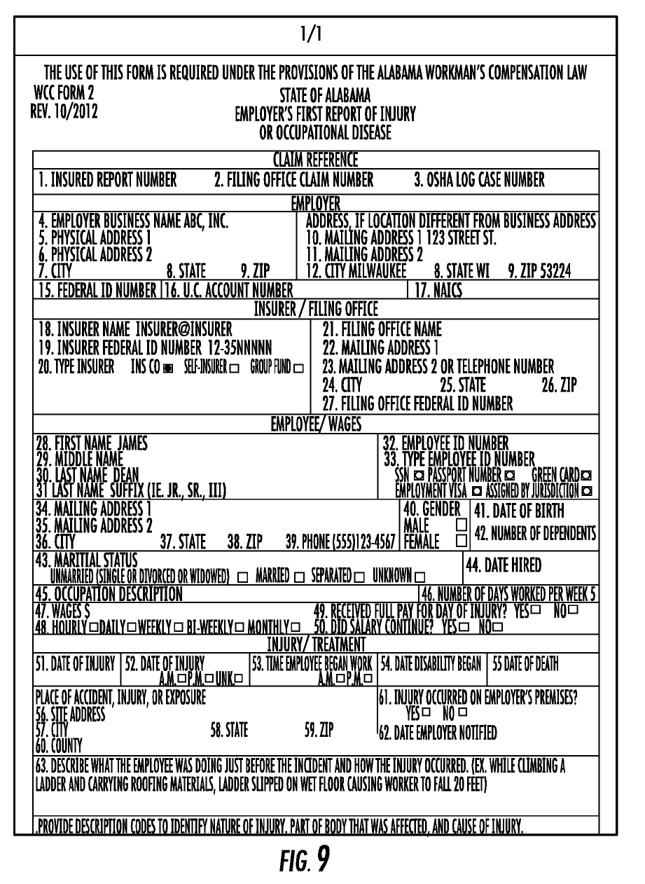

As show in FIG. 8, action specific window 88 associated with the “FIRST REPORT” action also includes save state operator 96, a conversion operator 98, and an end state operator 100. Save state operator 96 temporarily saves to either database 62 or some equivalent storage medium the data received in FROI report fields 94 for later editing. End state operator 100 can be activated when all the required data for the state specific FROI form has been received in the FROI report fields 94. In one embodiment, activating the end state operator finalizes the received data and temporarily prevents further editing of the FROI report fields 94. In one embodiment, FROI report fields 94 can be edited after activating end state operator 100 by re accessing action specific window 88 associated with the “FIRST REPORT” action. Conversion operator 98 converts the data received in the FROI report fields 94 into a compliant state specific FROI form by writing the current data in FROI report fields 94 into the previously mapped fields of the state specific form as shown in FIG. 9. In one embodiment, the state form is stored as a PDF document type. It should be noted that other compatible documents types are contemplated. In one embodiment, conversion operator 98 can only be activated after end state operator 100 has been activated. In another embodiment, conversion operator 98 can be activated at any time. In this embodiment, any required fields not yet populated with data will have to be entered manually later or a second conversion will need to be performed once the required data has been received in FROI report fields 94. The converted form can then be printed out and mailed to or electronically sent to the appropriate state office to comply with the state workers' compensation law requirements.

Referring now to FIG. 10 through FIG. 14, example screenshots of one embodiment for the addition of a healthcare provider user account to the claim file and initiating an additional video connection with the newly added healthcare provider account within system 48 are shown. FIG. 10 shows a screenshot of case specific window 82 when the “PARTIES” action is selected from action selection header bar 86. When the “PARTIES” action is selected, action specific content window 88 displays an associated party list 102 and add user type action operators 103. Associated party list 102 lists the details about the specific user accounts already associated with the active workers' compensation claim file. In one embodiment, the specific details include the name associated with the user account, the user type or role for each user account, and the contact details (e.g. email address and/or phone number) associated with each user account.

In one embodiment, party list 102 includes contact type specific operators 104 for each user account. Add user type action operators 104 include a send message operator 105 and a video invite operator 107. In one embodiment, activating send message operator 105 will generate a pop-up window where a message can be typed and then sent out using notification module 60. The means of communication (e.g. email, sms, etc.) employed by notification module 60 can be selected within the pop-up window. Add user type action operators 103 include specific operators for different user types that can be added to the case file. In one embodiment, the specific operators are limited to adding additional adjustors, healthcare providers, and other contacts. Other contacts can include user profile types such as the employer or additional third parties who may require regular updates related to the case file.

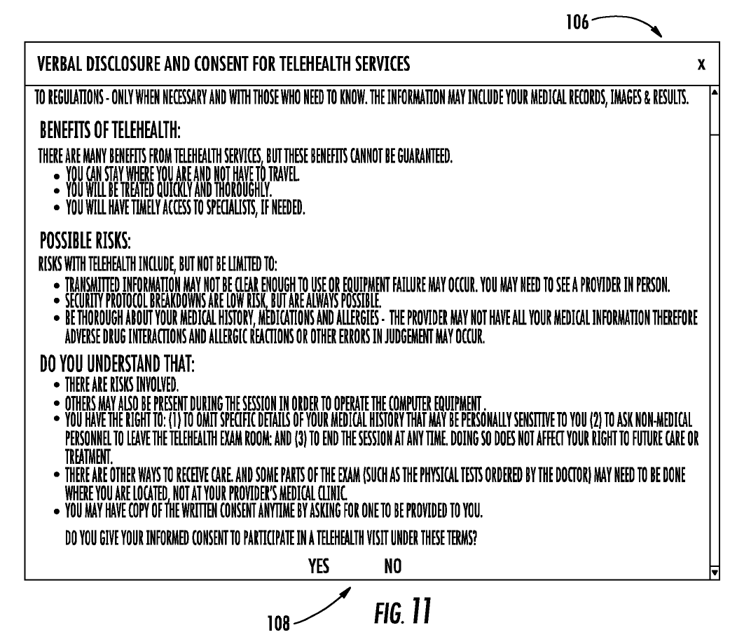

When the add provider operator of add user type action operators 103 is toggled, a consent form pop-up window or box 106 is displayed to the specific adjuster user account. Consent form pop-up box 106 is used to confirm consent for telepresence health treatment. As shown in FIG. 11, consent form pop-up box 106 includes verification operators 108 which receive either a “yes” or “no” response from the adjuster user account. The response received from the adjuster user account corresponds to information received over the still open video connection with the employee/worker user account. In an alternative embodiment, consent form pop-up box 106 is displayed to the employee/worker user account and the “yes” or “no” response is received by consent form pop-up box 106 directly from the employee/worker user account.

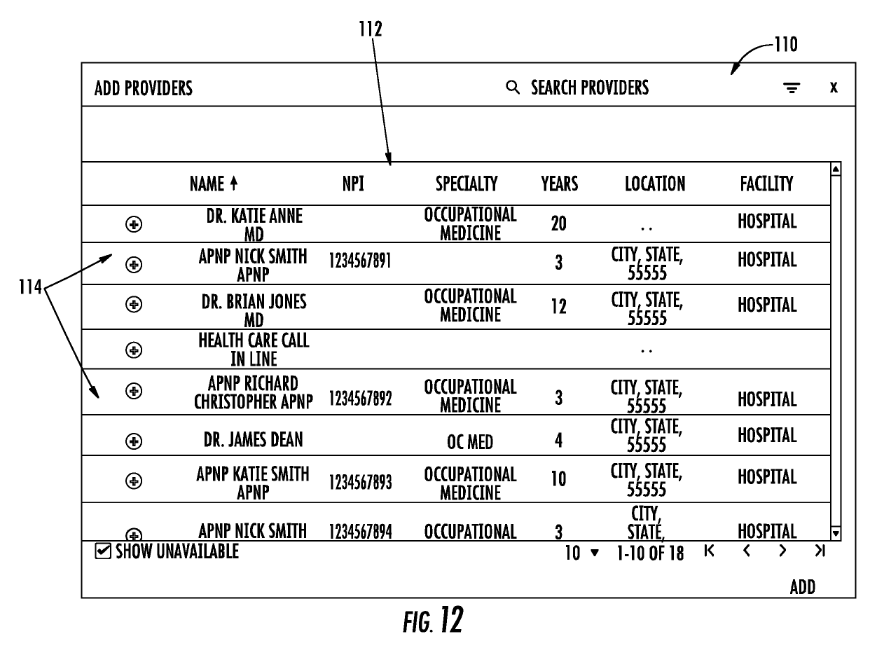

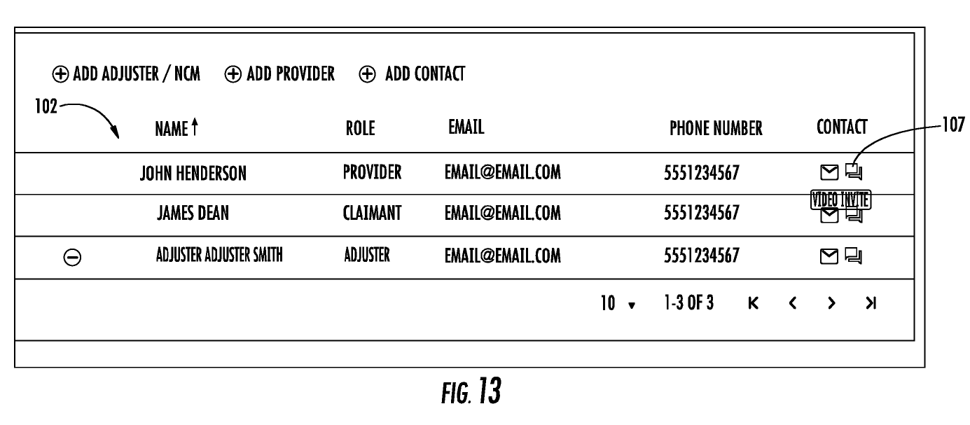

If a “no” response is received, the add provider action is terminated and adjuster user interface 72 returns to the view as shown in FIG. 10. If a “yes” response is received, a provider selection pop-up box 110 is displayed on adjuster user interface 72. As shown in FIG. 12, provider selection pop-up box 110 includes a list of providers 112 containing details about each specific provider (e.g. name of the provider, specialty, years of practice, location information, facility information, a national provider identity number such as NPI, etc.). Provider selection pop-up box 110 also includes add provider operators 114 next to each provider. Toggling the add provider operator 114 next to a listed provider will add that provider to the case file and return adjuster user interface 72 to the view as shown in FIG. 10 except that that the newly added provider will be listed in party list 102 as shown in FIG. 13. In an alternative embodiment, provider selection pop-up box 110 is displayed to the employee/worker user account and a provider selection is received from that user account instead of the specific adjuster account managing the current case file.

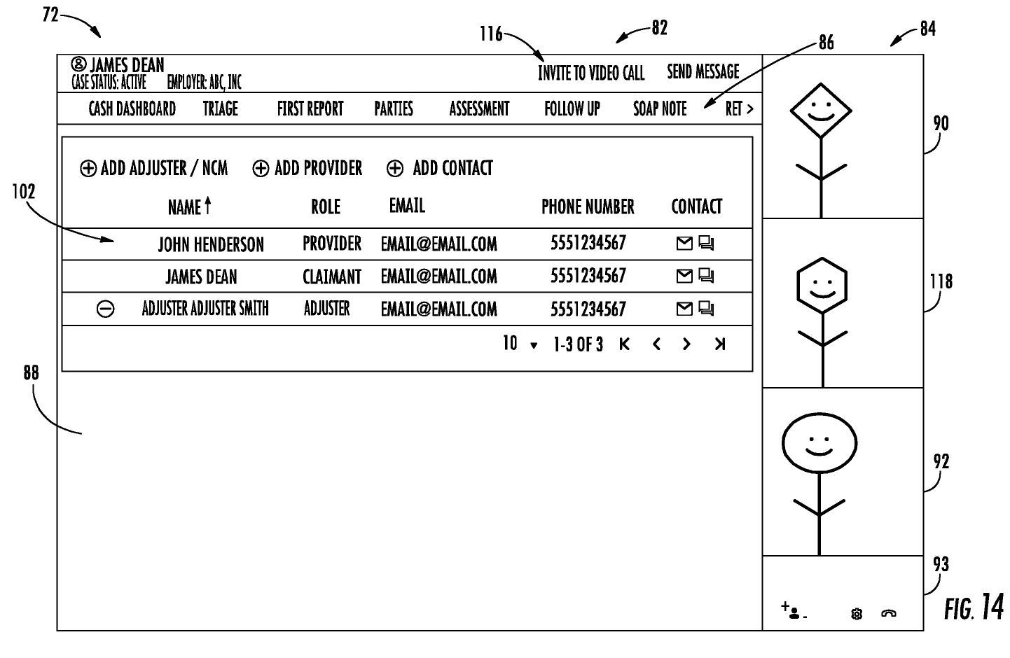

Once a provider has been added or associated with the current claim file, that provider can join the ongoing telepresence session by directing telepresence module 58 to establish an additional video connection between the provider user account and both the adjuster user account and the worker/employee user account. In one embodiment, the adjuster user account directs telepresence module 58 to establish the additional video connection by activating the video invite operator 107 associated with the newly added provider. The adjuster can also direct the telepresence module to establish the additional video connection by highlighting the provider and toggling an “Invite to video call” operator 116 at the top of case specific window 82 as shown in FIG. 14. Once directed to establish the additional video connection, telepresence module 58 sends a message containing a link to a least one of the provided contact details associated with the provider user account. System 48 then receives an incoming transmission request from the provider user account when the sent out link is activated and establishes the additional video connection with the provider user account by displaying a second remote view window 118 as shown in FIG. 14. In one embodiment, establishing the video connection with the provider user account automatically terminates recording of the video connections and saves the previously recorded video as a file in database 62.

Further, the system 48 can also add a provider based on a number of factors such as, but not limited to, the immediate availability of the provider, the medical licensure of the provider, or the provider's number of open appointments, etc.

In one embodiment, the party list 102 will include information that indicates if the medical provider is immediately available for a consolation or if the medical provider has available times to schedule a consultation with the user.

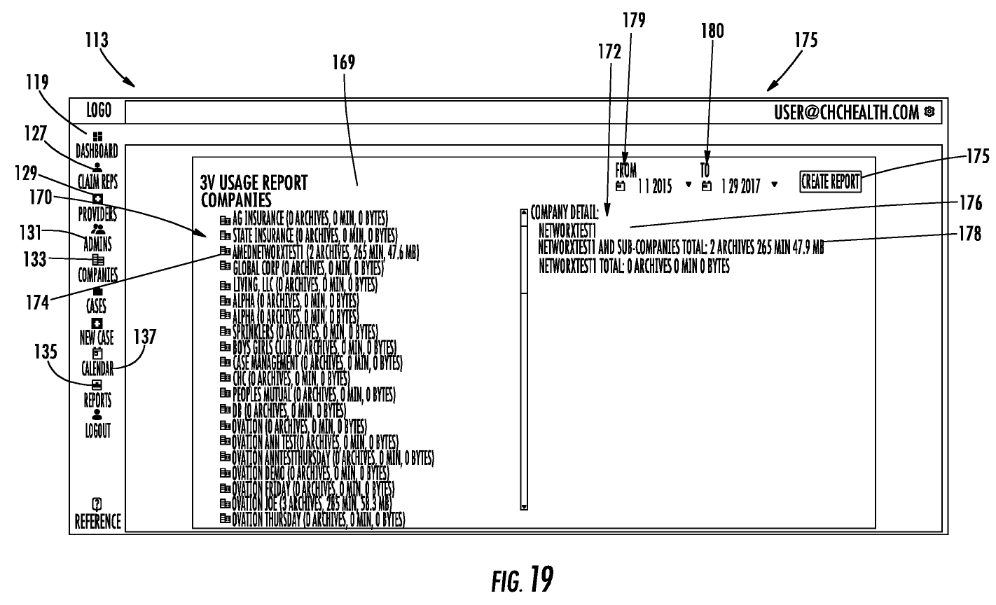

In another embodiment, when the provider add user type action operator 103 is toggled and the medical provider is immediately available then the user will continue with adding the medical provider as discussed above. However, if the user toggles the provider add user type action operator 103 and the medical provider is not available for an immediate consultation the calendar operator 137 of the user's selection window 76, 119 will open and provide the medical provider's availability to schedule an appointment or consultation (see FIG. 6; see also FIG. 19). If the medical provider has an availability that is agreeable to the user then the user can schedule that time and date with the medical provider on their calendar provided by the calendar operator 137 to have the appointment or consultation.

In one embodiment, when the user finalizes the time and date of the appointment or consultation in their calendar it will also be reflected on the medical provider's calendar when the medical provider toggles his or her calendar operator 137.

In another embodiment, when the user finalizes the time and date of the appointment or consultation in their calendar it will be pending upon approval of the medical provider and when accepted by the medical provider it will be reflected on the user and medical providers calendars in the system 48.

Further, in another embodiment when a medical provider is first registered as a user in the system 48, the medical provider will be prompted by the system 48 to provide bibliographical and professional information to be stored in the system 48, such as, but not limited to, the state or states where the medical provider is licensed to practice medicine, the medical provider's medical license registration number(s), the years that they have been registered to practice medicine, the medical school they attended, etc. Once entered, the file management module 56 will store the medical provider's information in the database 63 of the system 48, where it can be retrieved by the file management module 56 when prompted by a user.

For example, in one embodiment, when a user toggles the provider add user type action operator 103 it will prompt the file management module 56 to cross-reference the worker/employee's home state or the state where the worker/employee plans to seek medical treatment with the states that the medical providers stored in the system 48 are licensed to practice medicine. The system 48 can them compile and provide to the user a list of medical providers that contains only those medical providers that are licensed to practice medicine in the worker/employee's home state or that state where the worker/employee plans to seek medical treatment.

Further, the system 48 can also provide a user with a list of medical providers that are immediately available or have open appointments according to the information pulled from the medical providers calendar in the system 48, as well as ensuring that the medical provider that is ultimately selected by the worker/employee is licensed to practice medicine in the state where the worker/employee resides or in the state where the worker/employee will ultimately be seeking treatment.

As will be understood, this allows a user of the system 48 to significantly streamline the process of selecting a properly licensed medical provider and also prevents medical providers from having to respond to requests to schedule an appointment for a medical consultation that they cannot perform due to scheduling conflicts and/or that they are not licensed to practice medicine in the injured worker/employee's home state or the state where the worker/employee plans to seek medical treatment.

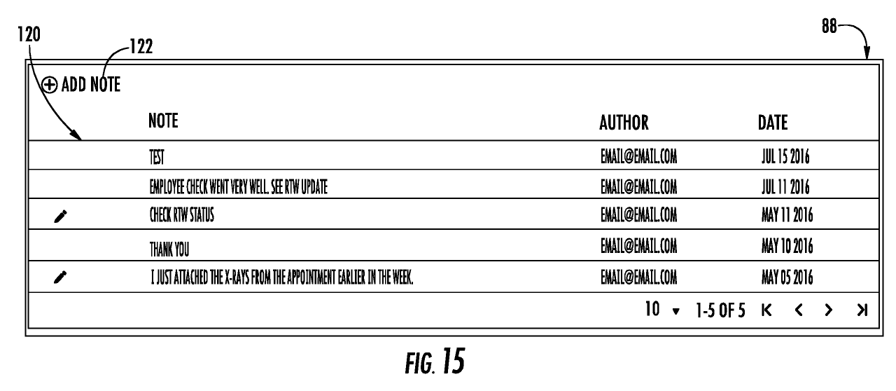

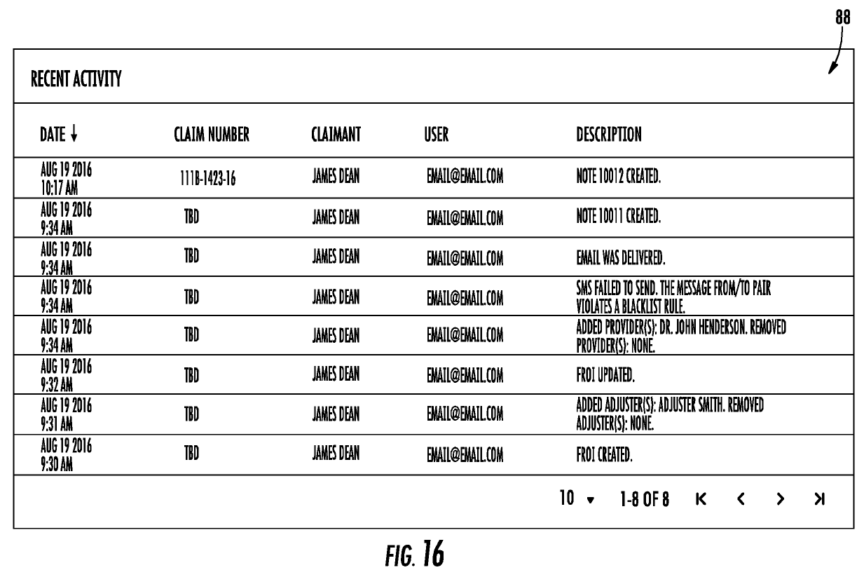

FIG. 15 through FIG. 16 show screenshots of various embodiments of action specific windows 88 associated with different actions from action selection header bar 86 shown in FIG. 7. FIG. 15 shows action specific windows 88 for an add note activity and includes a list of existing notes 120 associated with a specific workers' compensation case file. Notes 120 include at least a summary of the notes contents, the date, and author information. Also included is an add note operator 122. In one embodiment, activating add note operator 122 displays a pop-up window or box where the body of the note can be typed out and then saved in database 63 by file management module 56. The add notes action ensures pertinent information regarding the claim and the claimant's or worker's activities during the life of the claim are captured and stored until final resolution of the case.

FIG. 16 shows action specific window 88 for an activity review, case overview, case dashboard, or similar action and includes a listing of all the recent activity relating to a specific claim file. In one embodiment, the recent activity listing tracks message delivery for messages created within system 48 and sent out externally by notification module 60. As shown in FIG. 16 system 48 displays both error and confirmation indicators for messages originating from system 48.

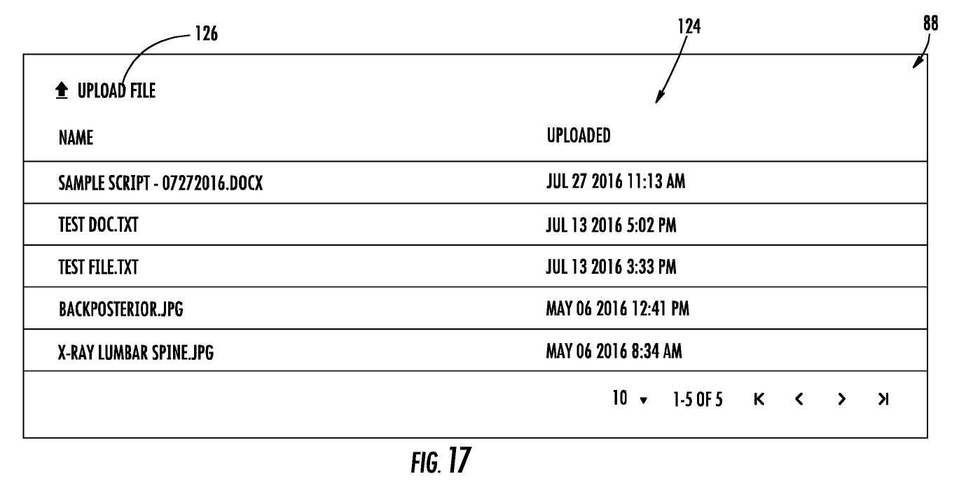

FIG. 17 shows action specific window 88 for an upload file or similar activity and includes a listing of data for uploaded files 124 including a title and an upload date. Also included in this version of action specific window 88 is an upload file operator 126. When upload file operator 126 is activated a pop-up window or box is shown and a location for a specific document to be uploaded is received within the pop-up window. A confirmation signal is received and the document is uploaded and stored in database 62 by file management module 56.

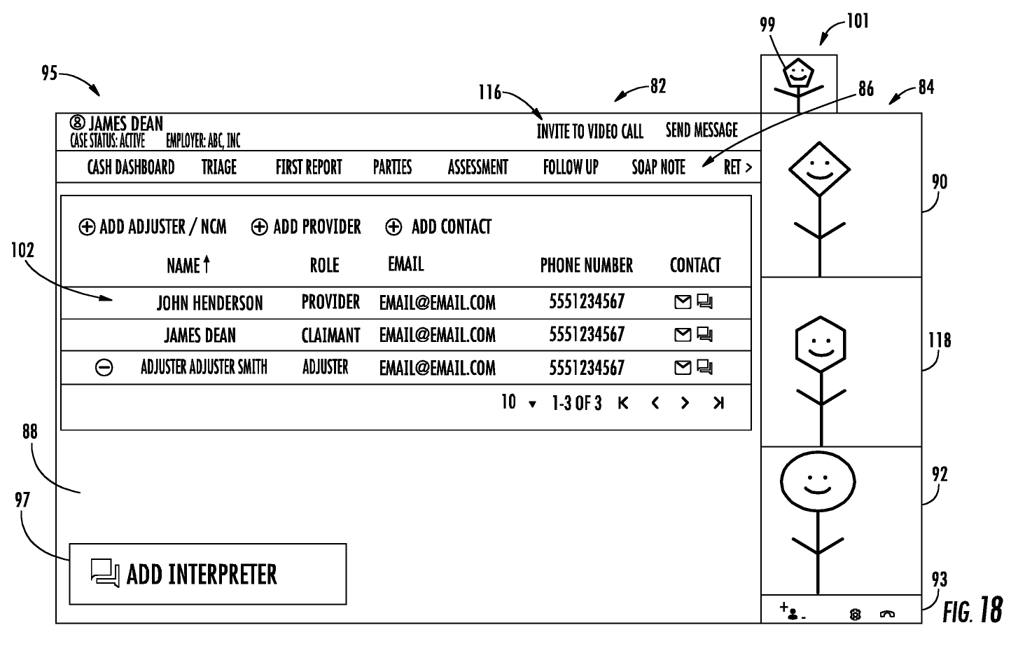

FIG. 18 is a screenshot of the graphical user interface 95 in conjunction with a telepresence session within the system of FIG. 4. The graphical user interface 95 includes a case specific window 82 and action specific content window 88. The action specific content window 88 includes a party list 102 of the users taking part in the telepresence conference call and illustrated in the local view window 92, the first remote view window 90, and the second remote view window 118. The action specific content window 88 also includes an add interpreter operation 97 that a user can toggle to request that a translator 99 be added to the telepresence conference call via a third remote view window 101 in order to provide language translation between any of the users in the local view window 92, the first remote view window 90 or the second remote view window 118.

In one embodiment when the add translator operator 97 is toggled, a pop up window or box is displayed to the user account that toggled the add interpreter operation 97. The pop up window or box may include a list of all available interpreters 99 along with the languages they are capable of helping the users translate between. The pop-up box may also be used to conform consent to establish the video connection with the third remote view window 101 that will include the translator 99. As shown in FIG. 11, a consent form pop-up box included a verification operator which receive either a “yes” or “no” response from the user account. The response received from the user account corresponds to information received over the still open video connection with the employee/worker user account.

In an alternative embodiment, a consent form pop-up box can be displayed on the employee/worker user account and the “yes” or “no” response to add a translator to the telepresence conference call is received directly from the employee/worker user account.

If a “no” response is received, the add translator operation 97 is terminated and adjuster the graphical user interface 95 will return to the telepresence conference call between the users in the local view window 92, the first remote view window 90, and the second remote view window 118. If a “yes” response is received, the video connection with the translator 99 is established and the third remote view window 101 will appear to provide language translations between the languages of an adjuster, employee/worker, health care provider, or any other person included on the party list 102.

FIG. 19 is a screenshot of an embodiment of a graphical user interface 113 within the system 48 of FIG. 4 The selection window 119 includes a dashboard, claim, new case, calendar and logout operator tabs that are the same as those discussed in the selection window 76 of the adjuster user interface 72 illustrated in FIG. 6. In addition to the above, the selection window 119 also includes a claim representative operation 127, a providers operation 129, an administrators operation 131, a company operation 133, and a report operation 135.

When a user toggles the claim representative operation 127 it allows a user to be set up in the system 48 as a claims representative to handle workers compensation claims that are stored in the system 48. Alternatively, when a user toggles the providers operation 129 it allows a user to be set up in the system 48 as an insurance provider. Further, when a user toggles the administrators operation 131 it allows the user to set up as an administrator with the system 48. Likewise, when a user toggles the company operation 133 it allows a user to set up a company in the system 48. As will be understood, the system 48 is modular in that it can be tailored to meet the specific needs of individual users. For example, the system 48 may have different graphical user interfaces for claims representatives, insurance providers, administrators, companies, etc.

As will be understood, due to the module nature of the system 48 different users can have different user interfaces including different functions that meet the specific of the user while also having each user operate on the same platform provided by system 48. This allows the system 48 to be both customizable for different user types while at the same time having the users operate on the same platform of system 48, which allows for the users to seamless share notes or messages relating to a claim, interact via telepresence to discuss a claim, share documents and/or date relating to a claim, etc.

FIG. 19 illustrates a screenshot of the graphical user interface 113 after a user has toggled the report tab operator 135 located in the selection window 119. The report page 169 includes a usage report window 170 that includes a list of individual matters 174 accessible by the user. The user can create a report for each individual matters 174 by selecting the individual matter 174 from the usage report window 170 and then toggling the create report operator 175. Toggling the create report operator 175 prompts the file management module 56 to retrieve the relevant data and/or documents for the selected individual matter 174 that has been stored in the database 62 of the system 48. As will be understood, this provides the benefit of allowing a user to quickly and efficiently create a report for any individual matter 174 that the user has access to in the system 48.

The user can create a customizable report with data and/or documents created or stored in the database 62 of the system 48 during a certain timeframe by selecting a first date in the from date field 179 and a second later date from the to date field 180 and then toggling the create report operator 175. If the user elects to customize the dates by selecting a date range using the from date field 179 and/or the to date field 180 before toggling the create report operator 175 the file management module 56 will then sort the documents and/or data stored in the database 62 of the system 48 and include in the report only the documents and/or data for created or stored in the system according to the customized date ranges selected by the user in the to from date field 179 and/or the to date field 180.

In one embodiment when the user selects an individual matter 174 and toggles the create report operator 175 the file management module 56 will retrieve the relevant data and/or documents from the database 62 of the system 48 and create a link in a matter detail window 172. The link will allow the user to view or download the data and/or documents retrieved by the file management module 56 according to the parameters selected by the user.

In one embodiment the matter detail window 172 will include the title of the individual matter 174 along with data and/or document details 178. The data and/or document details 178 provided may include, but are not limited, the number data files or documents that have been retrieved by the file management module 56 according to the report parameters selected by the user, the minutes of video or voice files retrieved by the file management module 56 according to the report parameters set by the user, the file size of the data and/or documents retrieved by the file management module 56 according to the parameters set by the user, etc.

The usage report window 170 includes individual matters 174 sorted according to company name. However, the individual matters 174 listed in the usage report window 170 can also be sorted by, but is not limited to be sorted by, employee/worker name, names of the claim representatives responsible for the claim, by the title of the name of open claims, by the title of the name of closed claims, by the date of the claim, by the name of the providers associated with the claim, by the type of claim, by the insurance provider associated with the claim, etc.

In one embodiment the file management module 56 will sort the document and/or data stored in the database 62 of the system 48 according to a time stamp that indicates the time that the data or document was saved in the database 62 of the system 48.

In one embodiment the file management module 56 will sort the data and/or documents stored in the database 62 of the system according to a time stamp that indicates the time that the data or document was first created by a user in the system 48.

In one embodiment the file management module 56 will sort the document and/or data stored in the database 62 of the system according to a date that a user manually provided when saving the data or document in the database 62 of the system 48.

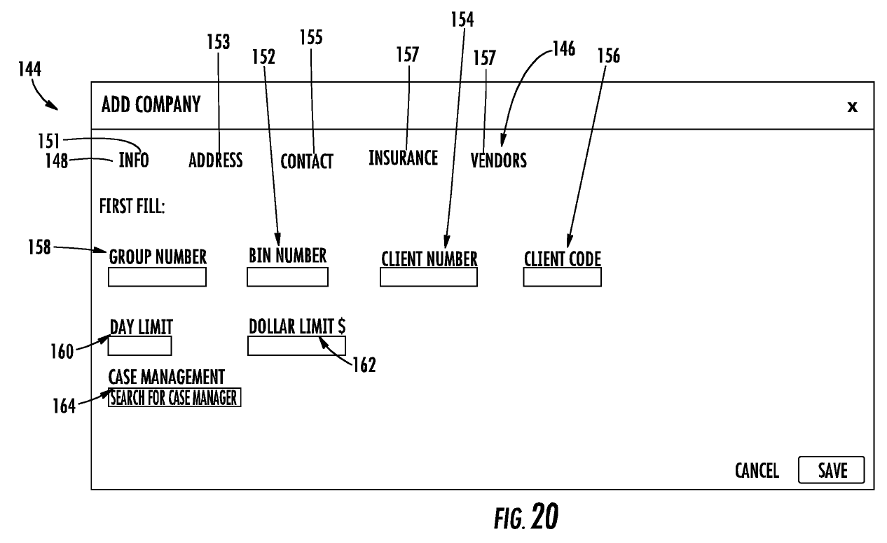

FIG. 20 shows a main window 144 for adding a new company to the system 48 of FIG. 4. The main window 144 includes an action selection header bar 146 and an action specific content window 148. Action selection header bar 146 includes a list of actions performable by the user account in relation to adding a company related to a workers' compensation claim file into the database 62 of the system 48. The action selection header bar 149 includes a general information operator 151, address information operator 153, a contact information operator 155, an insurance information operator 157, and a vendor information operator 159.

As will be understood, when a user selects the general information operator 151 an action specific window will be provided to the user including fields for the user to fill in with the general information regarding the new company to be added and stored in the system 48. Further, when the address information operator 153 is selected a new action specific window will be provided to the user including fields for the user to fill in with the address information of the new company to be added and stored in the system 48. Likewise, when the contact information operator 155 is selected by the user a new action specific window will be provided to the user including fields for the user to fill in regarding the contact information of the new company to be added to and stored in the system 48. Further, when the vendor information operator 159 is selected by the user a new action specific window will be provided to the user including fields for the user to fill in with the vendor information for the new company to be added and stored in the system 48.

In FIG. 20 the insurance information operator 157 has been selected by a user and action specific content window 146 has been provided including fields for the user to fill out with the insurance information of the new company to be added and stored in the database 62 of the system 48. The action specific content window 146 includes first fill insurance data fields 145 for the user to fill out during the new company set up process so that they can be stored in the database 62 of the system 48 and recalled by a user when needed.

The first fill insurance data fields 145 include specific fields for the Group Number 158, Bin Number 152, Client Number 154, Client Code 156, Day Limit 160 and Dollar Limit 162 for the first fill insurance data 145.

When all of the first fill insurance data fields 145 have been filled according to the insurance information for the new company being added to and saved in the system 48 the user can toggle the save state operator 165, which will prompt the file management module 56 to save the data entered into the first fill insurance data fields 145 in database 62 of the system 48. The first fill insurance data entered into the first fill insurance data fields 145 by the user will remain stored in the database 62 where a user can prompt the file management module 56 to retrieve the first fill insurance data from the database 62 where it can be used to auto populate a first fill insurance form for a claim submitted under the company's insurance policy.

In one embodiment, when a claim is submitted under the company's insurance policy the system 48 will automatically prompt the file management module 56 to retrieve the first fill insurance data previously entered into the first fill insurance data fields 145 that were saved and stored in the database 62 of the system 48 while adding the new company to the system 48. The system 48 can then automatically push the already filled out first fill prescription form to the employee/worker that filed the worker's compensation claim or to the pharmacy where the employee/worker has filled a prescription for any injury within the scope of the worker's compensation claim submitted by the employee/worker.

In one embodiment, when a claim is submitted under a company's insurance policy the system 48 will automatically prompt the file management module 56 to retrieve the first fill insurance data previously entered into the first fill insurance data fields 145 that were saved and stored in the database 62 of the system 48 while adding the new company to the system 48. The system 48 can then automatically push the completed first fill prescription form to the claim representative responsible for the worker's compensation claim for their review. Then the claim representative can determine if the first fill insurance form should be sent to the employee/worker that filed the worker's compensation claim or if the completed first fill insurance form should be directly submitted to the pharmacy where the worker/employee has filled a prescription for any injury within the scope of the worker's compensation claim submitted by the employee/worker.

By entering and storing the first fill insurance data into the first fill insurance data fields 145 during a new company set up the system 48 provides the benefit of automatically completing and pushing to a worker/employee their customized and completed first fill insurance form. As will be understood, this allows workers/employees using the system 48 to almost instantaneously receive their customized first fill insurance form, which prevents the worker/employee from having to pay out of pocket when filling their first set of prescriptions that are covered by the worker's compensation claim.

As will also be understood, by automatically completing and pushing the first fill insurance forms to the worker/employee the system 48 also eliminates the time and effort a claim representative handling the worker's compensation claim would normally need to allocate towards manually entering the first fill insurance data into a first fill insurance form before sending it to the worker/employee. Further, by automatically completing and pushing the first fill insurance forms to the worker/employee the system 48 also minimizes the amount of time a claim representative will need to allocate toward determining where the completed first fill insurance needs to be sent in order to reach the worker/employee and/or by what means the completed first fill insurance form needs to be sent in order to reach the worker/employee.

FIG. 20 also includes a case management operator 164. The case management operator 164 shows how individual sites or companies are related to a case management firm. This allows the user to further control data flow and allow for complexity outside of the simple child parent hierarchy. For example, a case management firm may be working with several different companies, but would only be able to see a subset of claims. The system 48 can determine which sites claims go through the case management firm at a hierarchal level.

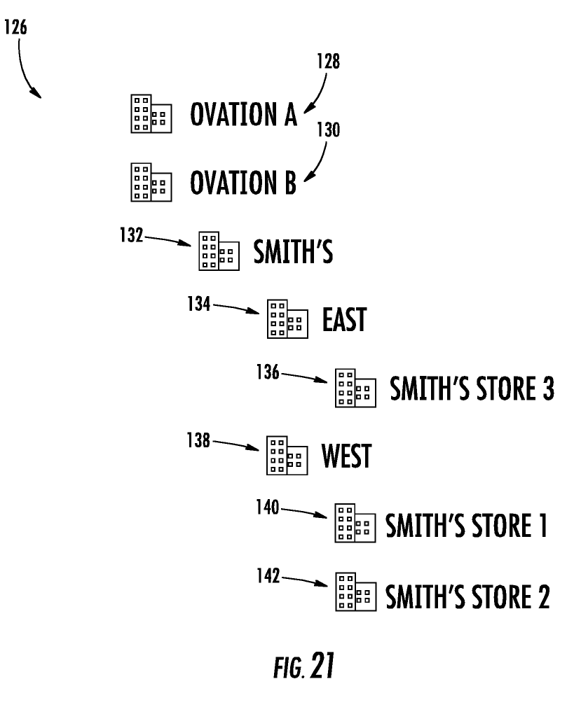

FIG. 21 shows one embodiment of a screenshot of a hierarchical path for a customizable data structure 126. The customizable data structure 126 illustrated in FIG. 20 allows a user to search or view claims stored in the system 48 according to the company they are associated with as well as subsidiaries of the company, or individual units or groups within the subsidiaries of the company, etc. As will be understood, a user using the system 48 can efficiently search, sort, and/or funnel documents and/or data related to individual groups or units that may make up a larger entity.

For example, the customizable data structure 126 illustrated in FIG. 21 shows a first parent company 128 and a second parent company 130. The second parent company 130 has a subsidiary company 132 that has a first division 134 and a second division 136. The first division 134 includes a first store 138 and the second division 136 includes a second and third store 140, 142. Therefore, using the customizable data structure 126 a user can search for the claim documents and/or data for all of the claims for the parent company 130. Alternatively, a user can only search for documents and/or data for the first division 134 or the second division 136 or a user may even just want to search for documents and/or data related to claims opened for the first store 138, or second store 140, or third store 142.

The customizable data can also be programmed to restrict the access of each individual user to only the first and second parent company 128, 130, only the subsidiary company 132, only the first and second divisions 134, 136, or even each individual store 138, 140, 142. As will be understood, this provides the benefit of both preventing unauthorized access to claim information to each individual level, but also provides an efficient way for a user to only have to search, sort, and/or funnel data that is relevant to the individual user.

For example, the customizable data structure 126 can be programmed to only allow the user responsible for supervising the claims of the first and second store 140, 142 to retrieve claim data for the first and second store 140, 142. This also prevents the user from accessing claim information that they do not have authorization to access, such as from any other entity beyond the first and second store 140, 142.

In addition, the customizable data structure 126 provides the benefit of limiting the claim data to only the claim data that is directly relevant to the first and second store 140, 142. As will be understood, by limiting the customizable data structure 126 to only the claim data of the first and second store 140, 142 the individual will not need to search, sort, and/or funnel through data that is not directly relevant to their responsibility of managing the claim data for the first and second store 140, 142. Further, users can also be setup in the system 48 as claim representatives that handle worker compensation claims in the system 48. The system 48 can also set up users for the purpose of the user providing a recorded statement regarding a claim. Once a user has made a recorded statement, the user can select a save operator that will automatically prompt the file management module 56 to save the recorded statement in the database 62 of the system 48 to be recalled by users of other accounts that have access to the specific claim in the system 48 that the user made the recorded statement for. In addition, the system 48 also can provide administrative reports that are only accessible as users listed as administrators in the system 48.

It should be understood that the above description of system 48 is described in relation to operation of the adjuster user interface 72. Various embodiments for the additional user interfaces 54 of system 48 that are both similar and different from the described adjuster user interface 72 are contemplated.

It should be understood that various embodiments of above identified system and method can be directed to uses outside the field of workers' compensation. Various embodiments of the system and method are directed to the fields of healthcare claim management, and patient management.

It should also be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A method for tracking a worker's injury and managing the claim process relating to the injury comprising:
connecting an injured worker to a video conference session with an insurance adjuster;
exchanging information relating to an injury suffered by the worker between the injured worker and the insurance adjuster over the video conference session;
electronically recording at least a portion of the video conference session to document the exchange of information;
storing the electronically recorded video conference session in an electronic database; and
linking the stored video conference session to an electronic case file containing additional information relating to the claim process for the worker's injury.

2. The method of claim 1 wherein the exchanged information is a first report of the injury.

3. The method of claim 1 further comprising accessing and updating the electronic case file outside of the teleconference session by the insurance adjuster.

4. The method of claim 1 wherein the insurance adjuster and the worker are located remotely from each other.

5. A method for tracking a worker's injury and managing the claim process relating to the injury comprising:
connecting an injured worker to a HIPAA compliant video conference session with a healthcare provider;
exchanging information relating to an injury suffered by the worker between the injured worker and the healthcare provider over the video conference session.

6. The method of claim 5 further comprising:
electronically recording at least a portion of the video conference session to document the exchange of information;
storing the electronically recorded video conference session in an electronic database in compliance with HIPPA patient data security requirements; and
linking the stored video conference session to an electronic case file containing additional information relating to the claim process for the worker's injury.

7. The method of claim 5 wherein the exchanged information is a S.O.A.P. note.

8. The method of claim 5 wherein the exchanged information is a return to work order.

9. The method of claim 5 further comprising accessing and updating the electronic case file outside of the video conference session by the healthcare provider.

10. The method of claim 1 wherein the healthcare provider and the worker are located remotely from each other.

11. A method for tracking a worker's injury and managing the claim process relating to the injury comprising:
connecting an injured worker to a multi-party HIPAA compliant video conference session with an insurance adjuster and a healthcare provider;
exchanging information relating to an injury suffered by the worker between the injured worker, the healthcare provider, and the insurance adjuster over the video conference session.

12. The method of claim 11 further comprising:
electronically recording at least a portion of the conference session to document the exchange of information;
storing the electronically recorded video conference session in an electronic database in compliance with HIPPA patient data security requirements; and linking the stored video conference session to an electronic case file containing additional information relating to the claim process for the worker's injury.

13. The method of claim 11 wherein the exchanged information is a first assessment of the injury.

14. The method of claim 11 wherein the exchanged information is a follow up assessment of the injury.

15. The method of claim 11 further comprising adding additional parties to the case file during the video conference session.

16. The method of claim 11 further comprising scheduling additional appointments during the video conference session.

17. The method of claim 11 further comprising attaching files to the case file during the video conference session.

18. The method of claim 11 further comprising downloading files from the case file during the video conference session.

19. The method of claim 11 wherein the insurance adjuster and healthcare provider can separately access and update the electronic case file outside of the teleconference session.

20. The method of claim 11 wherein the insurance adjuster, the healthcare provider, and the worker are located remotely from each other.

21. The method of claim 1 further comprising a network system including a user interface, a computer network, and a storage device.

22. The system of claim 21 wherein communication links between computers in the network and between the storage device are HIPPA compliant.

23. A system for managing workers' compensation claims comprising:
a plurality of user accounts, each user account having credentials indicating at least a user type and level of access; and
a centralized electronic portal comprising:
a plurality of user interfaces, each corresponding to one of the user types; a file management module comprising a database and a plurality of actions configured to create a new workers' compensation claim file, associate at least one of the user accounts with the workers' compensation claim file, create new documents for the workers' compensation claim file and store them in the database, retrieve and display documents for the workers' compensation claim file previously stored in the database, and edit documents for the workers' compensation claim file previously stored in the database, wherein at least one of the plurality of actions are accessible by each of the plurality of user accounts based on the user type and level of access of its corresponding credentials;
a telepresence module configured to establish a video connection between at least 2 of the user accounts and record at least a portion of the video connection as a document in the database; and
a notification module configured to send an alert to at least one of the plurality of user accounts associated with the workers' compensation claim file.
